(19) United States
(12) Patent Application Publication
(10) Pub. No.: US 2007/0086580 A1
(43) Pub. Date: Apr. 19, 2007

(54) DATA TRANSMISSION SYSTEM, DATA TRANSMISSION METHOD, DATA TRANSMISSION APPARATUS, AND COMPUTER USABLE MEDIUM THEREFOR

(75) Inventor: Tomomi Wakazono, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/535,911

(22) Filed: Sep. 27, 2006

(30) Foreign Application Priority Data
Sep. 28, 2005 (JP) 2005282836

(51) Int. Cl. H04M 1/64

(52) U.S. Cl. 379/88.17

(57) ABSTRACT

A communication system, comprising a communication apparatus, an external memory unit, which stores a search criterion for destination information indicating a destination of communication that is designated under a predetermined criterion, a reader system, which reads the search criterion stored in the memory unit, a destination information obtaining system, which obtains the destination information that meets the search criterion read by the reader system from a destination information database, and a destination setting system, which designates the destination of communication based on the destination information obtained by the destination information obtaining system is provided.

### CROSS REFERENCE TO RELATED APPLICATION

This application claims priority from Japanese Patent Application No. 2005-282836, filed on Sep. 28, 2005, the entire subject matter of which is incorporated herein by reference.

### BACKGROUND

1. Technical Field

Aspects of the present invention relate to a data transmission system, data transmission method, data transmission device and a computer usable medium therefor.

2. Related Art

In an MFP (multiple function peripheral) having a plurality of functions, such as a function for printing to output data obtained from a facsimile device and other external devices, a function for copying to scan documents to generate image data and to output images based on the scanned image data, and a facsimile function to communicate with other facsimile devices, conventionally such a facsimile friction including registering transmission destinations and calling out one of the registered destinations to transmit the documents by a predetermined button operation are often used.

There is a known system called “directory service” for managing personal information and account information. Also, there is a known system configured for storing information of transmission destinations in the directory server and calling out the destination information stored in the server from the MFP to transmit documents.

As an example of such a device, i.e., an image forming apparatus, employing the service to obtain the destination information from an information administrating server such as an LDAP server is disclosed in Japanese Patent Provisional Publication No. 2004-274486.

### SUMMARY

Aspects of the present invention are advantageous in that a data transmission system, a data transmission method, a data transmission apparatus, and a computer usable medium therefor wherein the destination information database is easy to use while personal information is protected against unauthorized use, is provided.

### BRIEF DESCRIPTION OF THE ACCOMPANYING DRAWINGS

FIG. 1 is a schematic diagram showing an embodiment of a data transmission system according to an embodiment of the invention.

FIG. 2 is a block diagram showing an electrical configuration of an MFP according to the embodiment of the invention.

FIG. 3 illustrates an operation panel according to the embodiment of the invention.

FIG. 4 illustrates Telephone directory stored in the MFP according to the embodiment of the invention.

FIG. 5 is a block diagram showing an electrical configuration of the directory server according to the embodiment of the invention.

FIG. 6 illustrates a hierarchical tree structure in the directory server according to the embodiment of the invention.

FIG. 7 illustrates entry information stored in the directory server according to the embodiment of the invention.

FIG. 8 is a block diagram showing an internal configuration of a memory card according to the embodiment of the invention.

FIG. 9 illustrates search criteria stored in the memory card according to the embodiment of the invention.

FIG. 10 is a flow chart showing a data transmission process according to the embodiment of the invention.

FIG. 11 is a flow chart showing an address directory search process according to the embodiment of the invention.

FIG. 12 is a flow chart showing a query selection process according to the embodiment of the invention.

FIGS. 13A-13D illustrate screens shown on a display panel according to the embodiment of the invention.

### DETAILED DESCRIPTION

General Overview

The following describes general aspects of the invention that may or may not be included in various examples and modifications. It should be noted that various connections are set forth between elements in the following description. It should be noted that these connections in general and, unless specified otherwise, may be direct or indirect and that this specification is not intended to be limiting in this respect.

According to some aspects of the invention, there is provided a communication system, comprising a communication apparatus, an external memory unit, which stores a search criterion for destination information indicating a destination of communication that is designated under a predetermined criterion and is detachably attached to the communication apparatus, is provided. The communication apparatus comprises a reader system, which reads the search criterion stored in the memory unit a destination information obtaining system, which obtains the destination information that meets the search criterion read by the reader system from a destination information database, and a destination setting system, which designates the destination of communication based on the destination information obtained by the destination information obtaining system.

According to the above configuration, the search criterion is stored in the memory unit, and the destination of communication is designated by obtaining the destination information that meet requirements indicated in the search criterion so that communication can be established between the communication apparatus and the destination which is designated based on the search criterion. With this configuration, for example, when members of a department of an organization are transferred and exchanged while an employee A of the department has been designated as a destination based on a search criterion, a new destination can be automatically designated by updating the destination information database without updating the search criterion.

It should be noted that the communication between the communication apparatus and the designation may not limited to data transmission, but may include telecommunication using a telephone. Further, the destination information database may be provided internally and externally of the communication apparatus.

According to the above configuration, the external memory unit can be attached to and detached from the communication apparatus. When a plurality of external memory units, each of which stores a different search criterion, are provided, a destination of communication that meets a requirement indicated in the search criterion stored in one of the plurality of external memory units can be effectively searched.

Further, when the destination information database is provided externally of the communication apparatus, and the destination information database is shared by a plurality of the communication apparatuses, the destination can be searched as a destination of each communication apparatus by using a same external memory unit.

Optionally, the external memory unit may store authentication information that is used for accessing the destination information database. The communication apparatus may be provided with an authentication information reader system which reads the authentication information from the detachable device, and an accessing system which accesses the destination information database using the authentication information read by the authentication information reader system.

It should be noted that, if a user attempts to access the destination information in the destination information database from a relatively small communication apparatus having no specific input unit such as a keyboard, it would be difficult to authenticate whether the user has a right to use information stored in the destination information database by requesting entry of a user name and a password before permitting the use of the destination information database. According to the above configuration, however, the user accessing the destination information database using the communication apparatus with no specific input unit can be authenticated by using the authentication information stored in the external memory unit.

Optionally, the communication apparatus may further comprise a plurality of communication units to communicate with the destination of communication. The external memory unit may store a first search criterion for designating information that designates the destination of communication and a second search criterion for communication method to communicate with the destination of communication while the designating information and the communication method of the destination of communication are associated with each other to be stored in the destination information database. The destination information obtaining system may obtain the communication method that meets the second search criterion to communicate with the designation of communication that meets the first search criterion from the destination information database. Communication between the communication apparatus and the destination may be established by using one of the plurality of communication units to which the communication method obtained by the destination information obtaining system is applicable.

According to the above configuration, a communication method of the communication apparatus to communicate with the destination can be searched based on the second criterion. Therefore, for example, when the second criterion indicates as to whether the communication is e-mail transmission or facsimile transmission, a suitable communication method for the transmission can be effectively searched.

Optionally, the communication apparatus may further comprise an operation inputting system, wherein an operation from a user is inputted. The reader system may read the search criterion from the memory unit according to the operation inputted through the operation inputting system.

According to the above configuration, for example, as the user inputs a predetermined operation, such as one-touch dialing and speed (abbreviated)-dialing, through the operation inputting system, the destination information according to the operation can be effectively read from the memory unit.

Optionally, the communication apparatus may be capable of obtaining the destination information from a plurality of destination information databases, and may further comprise a judging system, which judges as to whether the destination information has been obtained from one of the plurality of destination information databases by the destination information obtaining system. The destination information obtaining system may obtain the destination information that meets the search criterion from another destination information database when the judging system judges no destination information has been obtained from the one of the plurality of destination information databases.

According to the above configuration, when the destination information cannot be obtained from one of the destination information databases, the destination information can still be obtained from another destination information database.

According to another aspects of the invention, there is provided a communication apparatus, comprising a communication system, capable of communicating with an external memory unit that stores a search criterion for destination information indicating a destination of communication that is designated under a predetermined criterion, a reader system, which reads the search criterion obtained from the external memory unit by using the communication system, a destination information obtaining system, which obtains the destination information designated based on the search criterion read by the reader system from a destination information database, and a destination setting system, which designates the destination of communication based on the destination information obtained by the destination information obtaining system.

According to the above configuration, the external memory unit can be provided externally of the communication apparatus. Thus, when the destination information database is shared by a plurality of the communication apparatuses, the destination can be searched as a destination of each communication apparatus.

According to another aspects of the invention, there is provided a communication system, comprising a communication apparatus, a destination information database wherein destination information indicating a destination of communication with the communication apparatus is stored, and a memory unit, which stores a search criterion for the destination information that is designated under a predetermined criterion. The communication apparatus comprises a reader system, which reads the search criterion stored in the memory unit, a destination information obtaining system, which obtains the destination information designated based on the search criterion read by the reader system from the destination information database, and a destination setting system, which designates the destination of communication based on the destination information obtained by the destination information obtaining system.

According to the above configuration, the communication system wherein the destination information database is easily used by establishing communication between the memory unit and the communication apparatus can be achieved.

According to another aspects of the invention, there is provided a method of controlling a communication system, comprising reading a search criterion for destination information indicating a destination of communication that is designated under a predetermined criterion stored in a memory unit, obtaining the destination information which is designated based on the search criterion read from a destination information database storing the destination information, and designating the destination of communication based on the obtained destination information.

According to the above method, a communication system wherein the destination information database is easily used by establishing communication between the memory unit and a communication apparatus can be achieved.

According to another aspects of the invention, there is provided a computer usable medium comprising computer readable instructions for controlling a computer to execute steps of a reading step to read a search criterion for destination information indicating a destination of communication that is designated under a predetermined criterion stored in a memory unit, a destination information obtaining step to obtain the destination information which is designated based on the search criterion read from a destination information database storing the destination information, and a destination setting step to designate the destination of communication based on the destination information obtained in the destination information obtaining step.

According to the above computer usable medium, a communication system wherein the destination information database is easily used by establishing communication between the memory unit and a communication apparatus can be achieved.

### Embodiments

Hereinafter, referring to accompanying drawings, embodiments of the present invention will be described. A data transmission apparatus in the present invention includes an MFP in which a plurality of functions such as a facsimile transmission/reproduction function, an e-mail transmission function, a printing function, a scanning function, and a copying function are integrated into one. In the embodiments described below, a data transmission system wherein the MFP as a data transmission device having a facsimile transmission/reproduction function is provided in a network will be explained.

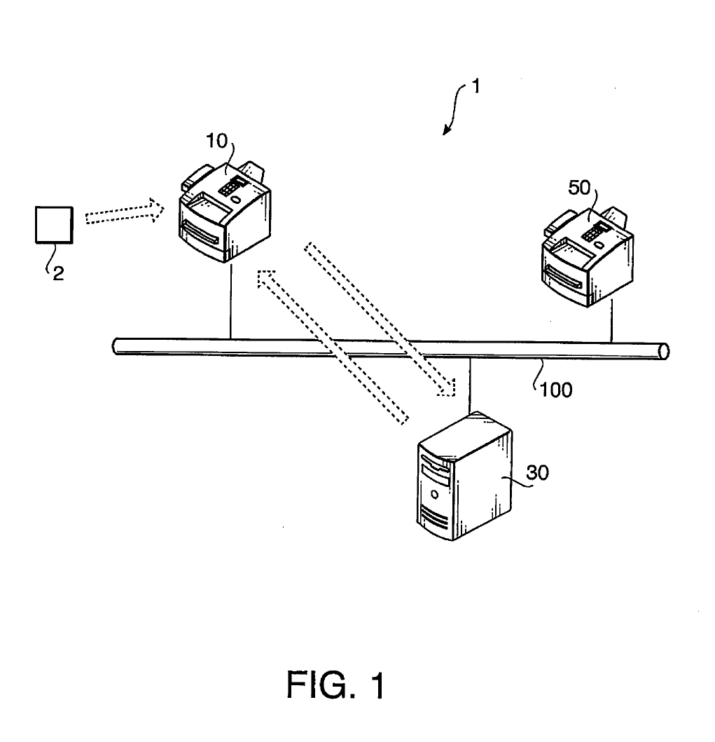

FIG. 1 is a schematic diagram showing the embodiment of the data transmission system 1 according to an embodiment of the present invention In the data transmission system 1 shown in FIG. 1, the MFP 10 is connected to the directory server 30 (e.g. an LDAP (Lightweight Directory Access Protocol) server) in which entry information including destination information is stored through a wired communication network 100. In the wired communication network 100, various cables including a serial communication cable, a parallel communication cable, and a LAN cable may be used. In the present embodiment, a LAN cable is used in the wired communication network 100. Also, a plurality of MFPs 10, 50 may be connected with the wired communication network 100.

Alternatively, the MFP 10 and the directory server 30 can be connected through a wireless communication network. For the wireless communication network, a wireless LAN, an IEEE 802.11x, and a Bluetooth (registered trademark) may be used.

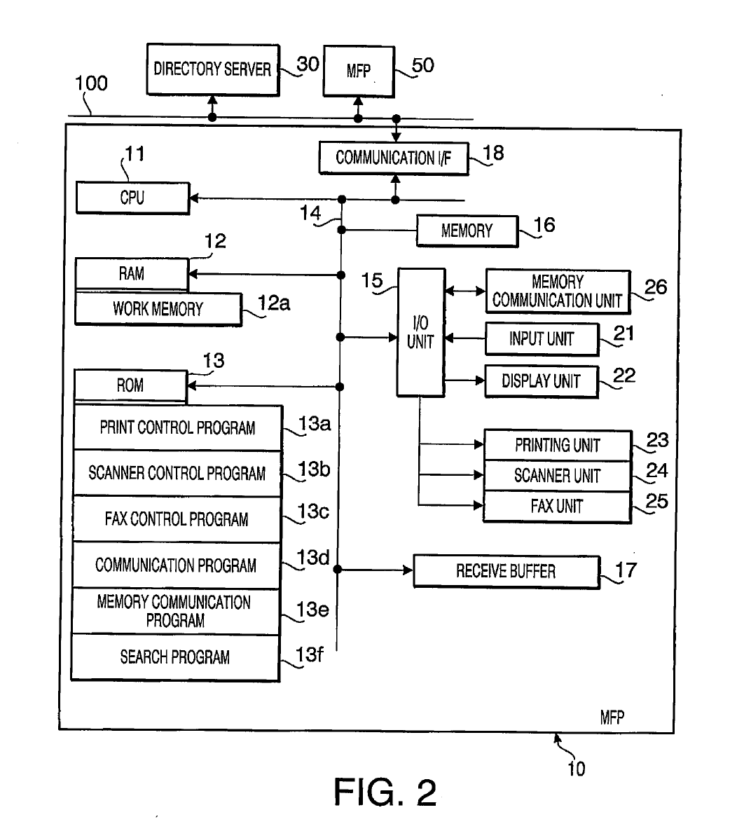

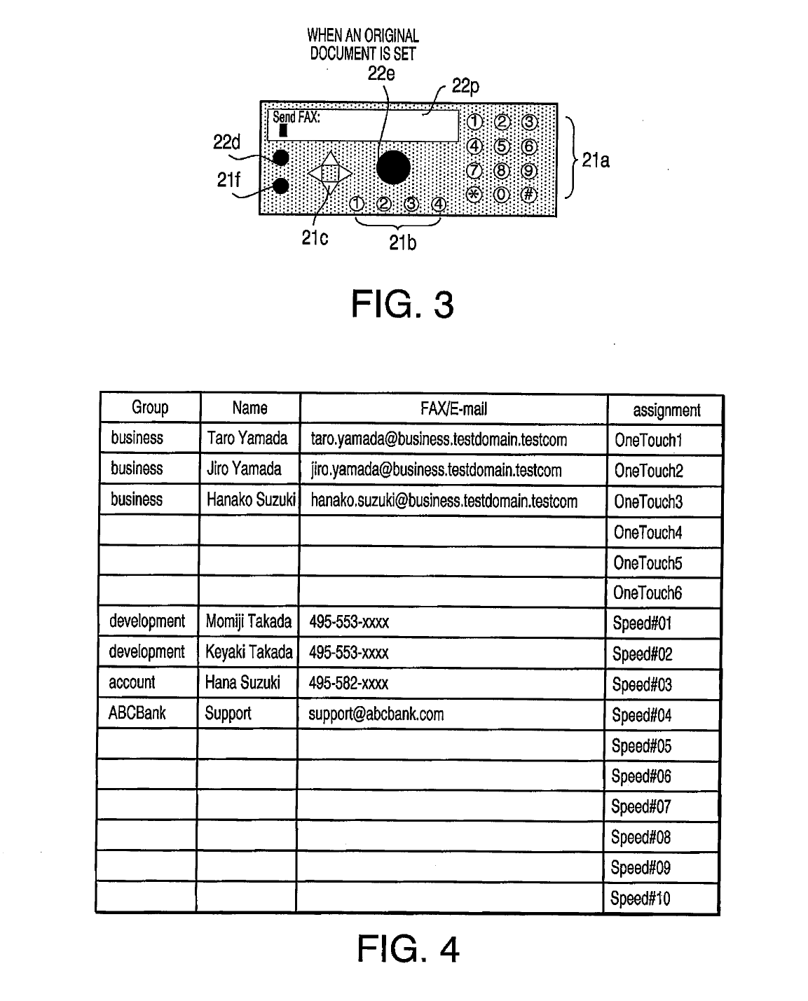

FIG. 2 is a block diagram showing an electrical configuration of the MFP 10 according to the embodiment of the invention. The MFP 10 comprises a CPU 11, a RAM 12 having a work memory 12a, a ROM 13 storing various programs, a bus line 14, an I/O (input/output) unit 15, a nonvolatile memory 16 (e.g. an EEPROM), a two-way communication I/F (interface) 18, which is connected to the wired communication network 100 for sending and receiving data to and from the directory server 30, and a receive buffer memory 17 (hereinafter, referred to as the “receive buffer 17”) in which received print control data is temporarily stored. The I/O unit 15 is connected with a memory communication unit 26, which can communicate with a memory card 2 being a mobile memory unit, an input unit 21 having a touch panel (not shown), push-button switches (see FIG. 3), a numerical keypad (see FIG. 3), and the like, a display unit 22 having an LCD (liquid crystal display) (see FIG. 3), and a printing unit 23 having a printing mechanism such as a known ink-jet printing mechanism, a laser printing mechanism, a thermal transfer printing mechanism, and a dot impact printing mechanism. A communication I/F 18 is an interface for wired communication and is connected to the wired communication network 100. A print control program 13a, a scanner control program 13b, a facsimile control program 13c, a communication program 13d, a memory communication program 13e, and a search program 13f are stored in the ROM 13.

FIG. 3 illustrates an operation panel 22a of the input unit 21 and the display unit 22 when an original document is set in the MFP 10 according to the embodiment of the present invention. The operation panel 22a comprises a display panel 22p, input buttons 21a, one-touch dial buttons 21b, selection buttons 21c an Enter button 21d, a transmission start button 21e, and a designation button 21f.

With the operation panel 22a, a user can enter a number sequence such as a telephone number through the input buttons 21a. The operation panel 22a is provided with the one-touch dial buttons 21b having push-buttons, with numeric symbols for example from 1 to 4. Each one-touch dial button 21b is provided with a numeric symbol and can be assigned information such as a telephone number, a facsimile number, an e-mail address, a folder name. With the one-touch dial buttons 21b, the user can select the corresponding information assigned to the one-touch dial buttons 21b simply by specifying the one-touch dial buttons 21b with the corresponding numeric symbols. Therefore, the user can communicate with a specified destination by one-push of one of the one-touch dial buttons 21b.

Further, the operation panel 22a is provided with a designation button 21f, which is used when one of speed-dials is specified. The speed-dials, which are for example two digit numbers from 10 to 99, are registered in association with information such as telephone numbers, facsimile numbers, e-mail addresses. When the speed-dial is used, one of the two digit numbers corresponding to a desired information is specified in combination with the designation button 21f Thus, the speed-dial allows the user to select the information assigned to the corresponding two digit number simply by specifying the corresponding number and the designation button 21f.

The display panel 22p is designed to display for example numbers inputted through the input buttons 21a in an LCD. When a selection is made from a menu displayed on the display panel 22p by operating the selection buttons 21c and the Enter button 21d, data transmission can be executed by the transmission Start button 21e.

In the present embodiment, the MFP 10 is configured to have the printing unit 23, a scanner unit 24 for copying and image scanning, and a facsimile unit 25, which are connected to the I/O unit 15 to be controlled by the CPU 11. The operation of the printing unit 23, the scanner unit 24, and the facsimile unit 25 is conducted in a known manner, and the corresponding control programs, i.e., the print control program 13a, the scanner control program 13b, and the facsimile control program 13c stored in ROM 13, are controlled operationally by the CPU 11 running the programs on the work memory 12a in the RAM 12.

Further, the MFP 10 comprises an e-mail transmission function for sending and receiving e-mails, which are incorporated with image data for printing, through an external communication network connected to the wired communication network 100. The program to achieve the e-mail transmission function is a known program, and is incorporated in the communication program 13d stored in the ROM 13.

A memory communication program 13e is a program for communication between the memory communication unit 26 in the MFP 10 and the memory card 2. Search criteria stored in the memory card 2 are obtained by the CPU 11 of the MFP 10 by running the memory communication program 13e.

The search program 13f is a program for the MFP 10 to obtain the destination information, which is stored in the directory server 30, when the MFP 10 transmits data. The destination information is searched by the CPU11 of the MFP 10 by running the memory communication program 13f.

In the memory 16 of the MFP 10, Telephone directory (a phone book), in which personal names and company names with the destination information such as telephone numbers and e-mail addresses is stored. FIG. 4 illustrates the Telephone directory stored in the MFP 10 according to the embodiment of the invention. In the phone book, personal names or company names (Names) are stored in associated with affiliations (Group), facsimile numbers or e-mail addresses (FAX/E-mail), and assignments of one-touch dial buttons 21b or speed-dials (assignment). The information included in the Telephone directory can be searched by operating the input unit 21 of the MFP 10, and facsimile transmission to these telephone numbers and the Internet facsimile transmission to the e-mail addresses through a network are available.

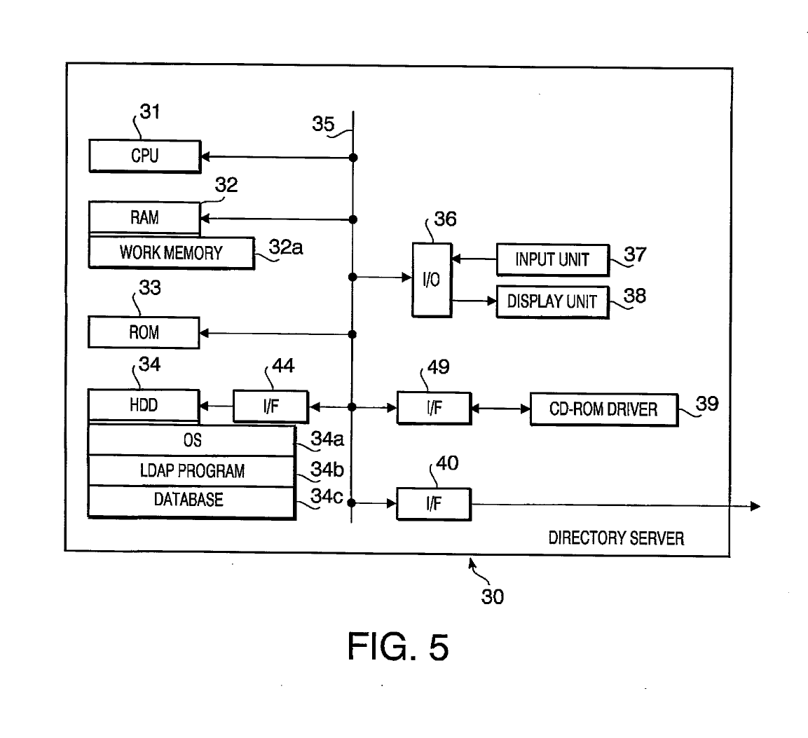

FIG. 5 is a block diagram showing an electrical configuration of the directory server 30 according to the embodiment of the invention. The directory server 30 is a computer such as a personal computer and a work station provided with a CPU 31, a RAM 32 having a work memory 32a, a ROM 33 storing various programs, an HDD (hard disk drive) 34 as a storage unit, a bus line 35, an I/O unit 36, a CD-ROM drive 39, a two-way communication I/F 40 which is connected to the wired communication network 100 for sending and receiving data such as print control data, The HDD 34 and the CD-ROM drive 39 are connected to the bus line 35 through the I/Fs 44, 49. An OS (operating system) 34a that is the fundamental software for the directory server 30, an LDAP program 34b that is executed to achieve a function of an LDAP server, a database 43c as a destination information database storing information such as entry information are stored in the HDD 34. An input unit 37 having input devices such as a keyboard and a mouse, and a display unit 38 having an LCD or a CRT (cathode ray tube) are connected to the I/O unit 36.

In present embodiment, the directory server 30 is configured as an LDAP server which can be accessed by using the LDAP, and the directory server 30 has a database 43c which stores entry information including the destination information. The database 43c stores personal names and entry information that is specific information associated with the personal names (i.e., affiliations, telephone numbers, facsimile numbers, and e-mail addresses)

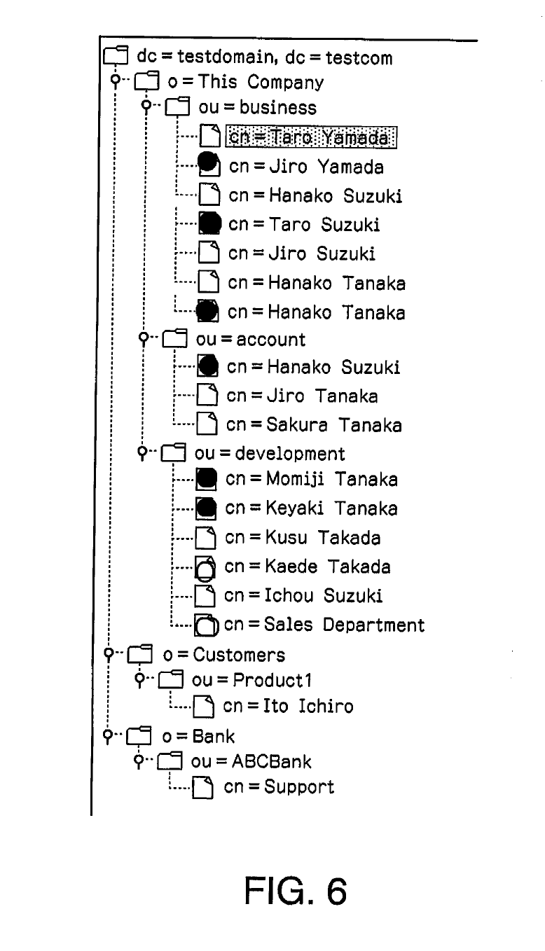

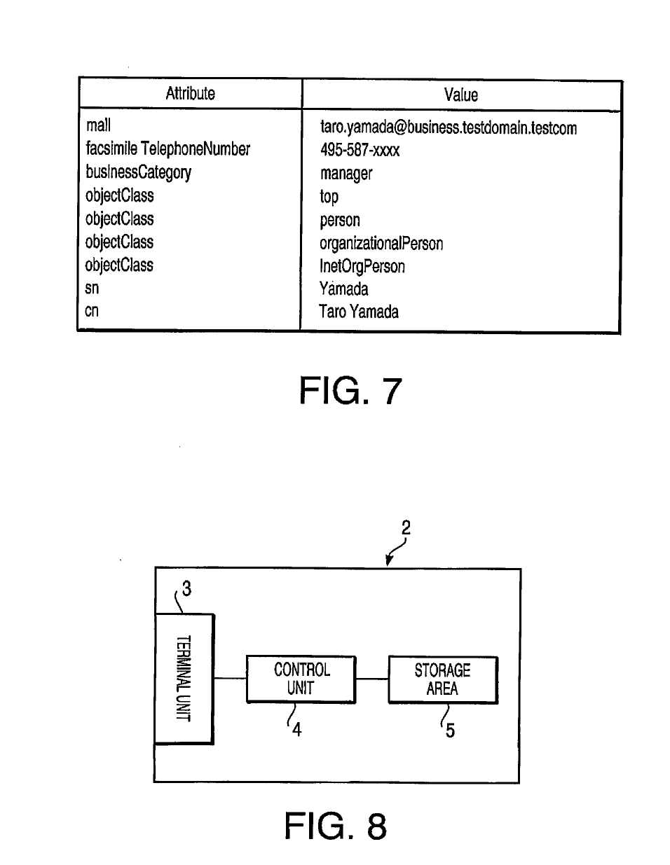

In the directory server 30, persons and organizations are arranged in a hierarchical tree structure, and the information related to each person is stored in the database 43c as individual entry information. FIG. 6 illustrates the hierarchical tree structure in the directory server 30 according to the embodiment of the invention, and FIG. 7 illustrates the entry information stored in the directory server 30 according to the embodiment of the invention. Entry information includes attributes such as “c” (country), “de” (domain component), “o” (organization), “ou” (organization unit), “cn” (common name), “sn” (surname), “mail” (e-mail address), “telephone” (telephone number) and “facsimileTelephoneNumber” (facsimile number). As shown in FIG. 6, each entry information is hierarchized.

Various requests and responses are exchanged repeatedly between the directory server 30 and the MFP 10 as an LDAP client. For example, when a “search” is requested from the MFP 10 to the directory server 30, the directory server 30 returns “search result” to the MFP 10. By using this function, a search request for the entry information including the destination information (for example the facsimile phone numbers and e-mail addresses) is issued from the MFP 10 to the directory server 30, thus, data transmission such as facsimile transmission, Internet facsimile transmission, and e-mail transmission according to the search results can be executed.

FIG. 8 is a block diagram showing an internal configuration of the memory card 2 according to the embodiment of the invention. The memory card 2 is provided with a terminal unit 3, a control unit 4, and a storage area 5, and the storage area 5 consists of a semiconductor memory in which contents therein can be rewritten. The contents are rewritten by an electric device (not shown) connected electrically through the terminal unit 3. The memory card 2 stores information such as search criteria and passwords in the storage area 5, and the contents in the storage area 5 are read out by the MFP 10. The memory card 2 may be a noncontact IC memory card which performs data communication through electromagnetic waves without contacting the electric device.

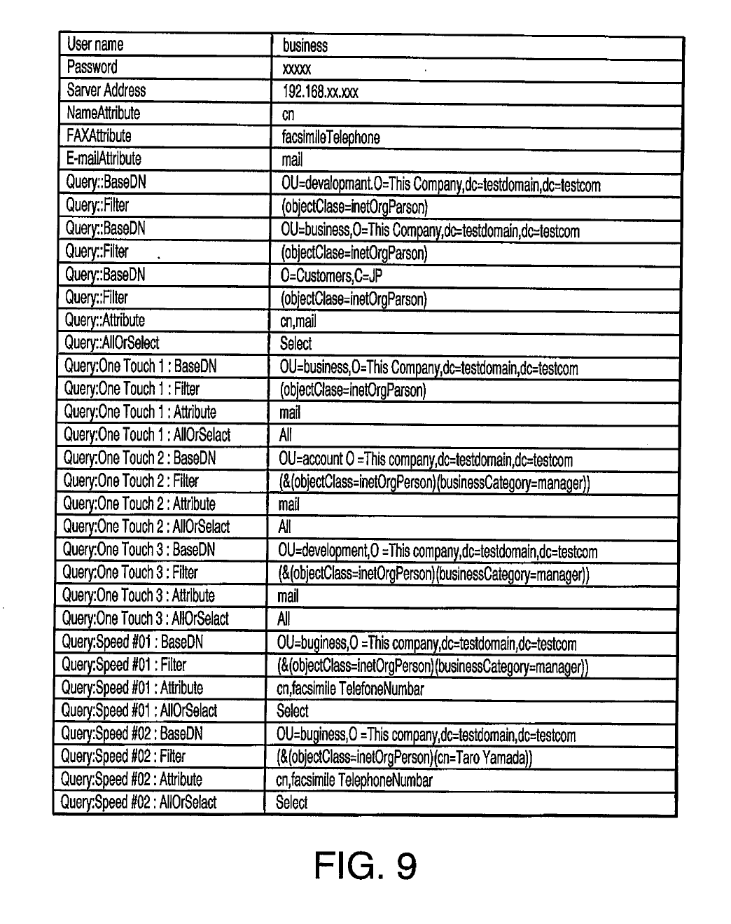

FIG. 9 illustrates the search criteria stored in the memory card 2 according to the embodiment of the invention. “User name” and “Password” are a user name and a password corresponding to the user name. As the MFP 10 reads the memory card 2, the user name and the password are read, and the user logs in the directory server 30. “Server Address” specifies the address of the directory server 30. “NameAttribute”, “FAXAttribute”, and “E-mailAttribute” indicate the attributes in the entry information, which corresponds to the information (Names and FAX/E-mail) registered in the phone book of the MFP 10, stored in the directory server 30. “NameAttribute”, “FAXAttribute”, and “E-mailAttribute” respectively correspond to “cn”, “facsimileTelephoneNumber”, and “mail” in the entry information.

“Query::BaseDN” represents a root directory for search, and “Query::Filter” represents the search criteria. For example, “objectClass=inetOrgPerson” incidates a search is conducted upon a criterion wherein a subject is a “person”. Further, “&(objectClass=inetOrgPerson)(businessCategory=manager)” indicates a search is conducted upon a criterion wherein a subject is a “person and manager”. Furthermore, three occurrences of “Query::BaseDN” indicate a search is conducted over three directories.

“Query::Attribute” indicates information to be obtained by the search. “cn,mail” indicates a name (cn) and an e-mail address (mail) are obtained. “Query::AllOrSelect” indicates as to whether all or only selected entry information is obtained when entry information is detected.

Further, each occurrence of “Query:One Touch 1” indicates “directory to be searched”, “information to be searched”, “information to be obtained”, and “obtain all/selected information” respectively, when one of the one-touch dial buttons 21b (one-touch dial button “1”) is pressed.

Similarly, each occurrence of “Query:Speed #01” indicates “directory to be searched” “information to be searched”, “information to be obtained”, “obtain all/selected information” respectively, when the speed-dial “01” is specified.

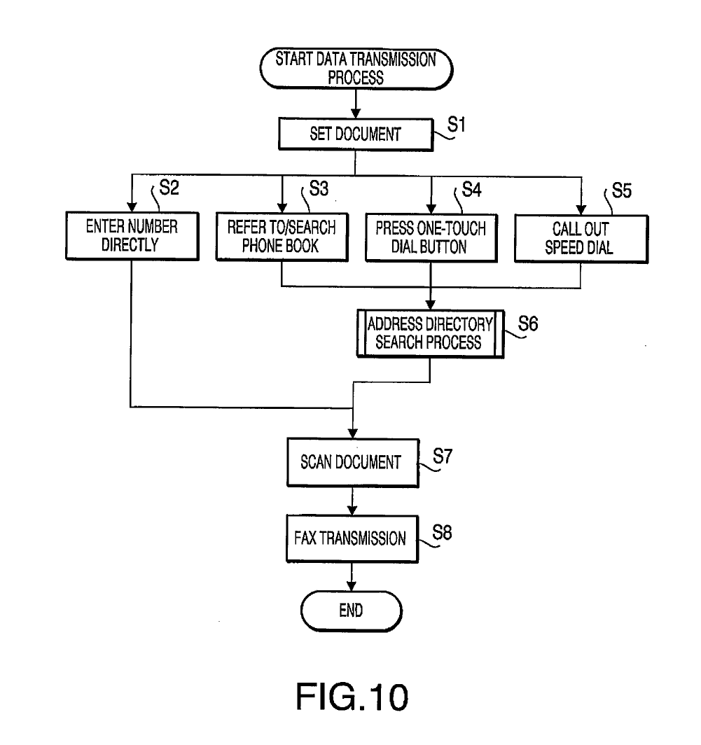

Referring to FIG. 10, a process to be executed in a data transmission is explained hereinbelow. FIG. 10 is a flow chart showing the data transmission process according to the embodiment of the invention. A user sets a document that contains data to be transmitted on the MFP 10 (S1). Thereafter, the user executes one of the following four operations described in S2 through S5. In this context, it should be noted that in order to utilize the entry information in the directory server 30, it is necessary to load the memory card 2 into the MFP 10 in advance so that the search criteria in the memory card 2 can be read out. In S2, the user enters a destination telephone number directly by manipulating the operation buttons of MP10. In S3, the user refers to the registered phone book to search the destination information. In S4, the user presses one of the one-touch dial buttons 21b of the MFP 10. In S5, the user uses the speed-dial of the MFP 10.

When S2 is selected, the MFP 10 scans the document (S7), and executes a conventional FAX transmission process (S8). Thus, the data is transmitted from the MFP 10. In this case, no entry information in the directory server 30 is searched.

When S3, S4, or S5 is selected, the MFP 10 executes an Address directory search process, wherein the entry information registered in the directory server 30 or the Telephone directory registered in the directory server 30 is searched (S6). Thus, a facsimile number is searched for facsimile transmission and an e-mail address is searched for Internet facsimile transmission

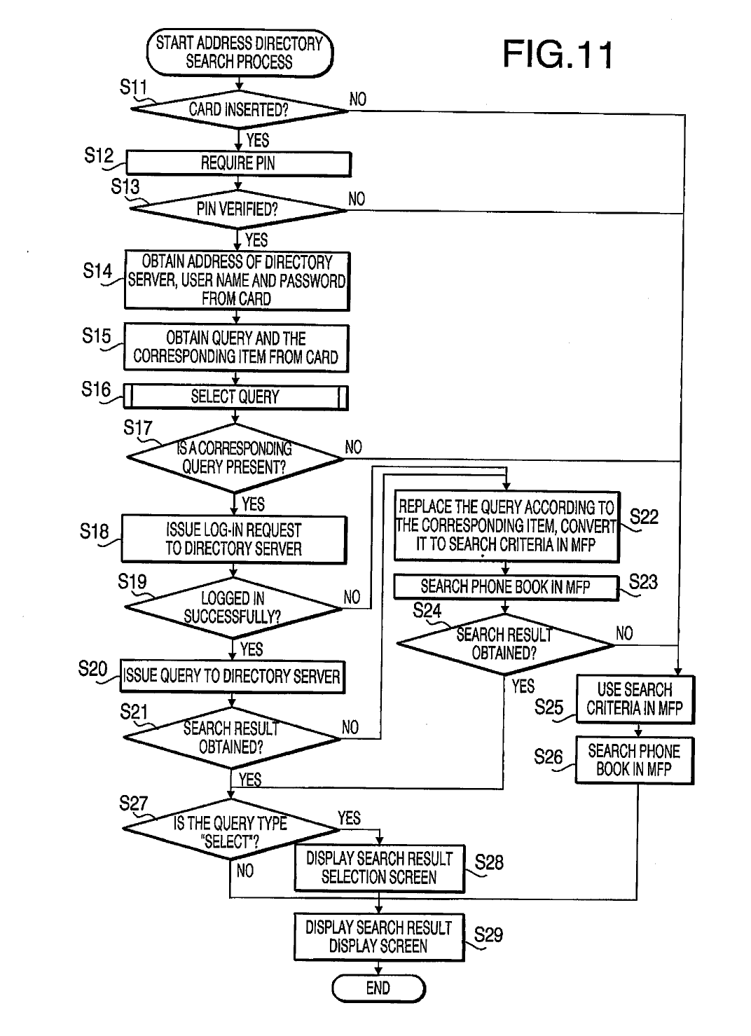

Referring to FIG. 11, the address directory search process is explained hereinbelow. FIG. 11 is a flow chart showing the address directory search process according to the embodiment of the invention. The CPU 11 of the MFP 10 judges whether the memory card 2 has already been inserted in the memory communication unit 26 (S11). If the memory card 2 is in place, the CPU 11 requests the user to enter a PIN (personal identification number) as an identification code (S12). If the CPU 11 judges the PIN is correct (S13: YES), the CPU 11 obtains the address of the directory server 30, the user name, and the password stored in the memory card 2 (S14). Next, the CPU 11 obtains queries and the items corresponding to the queries from the memory card 2 (S15), and executes a query selection process (S16).

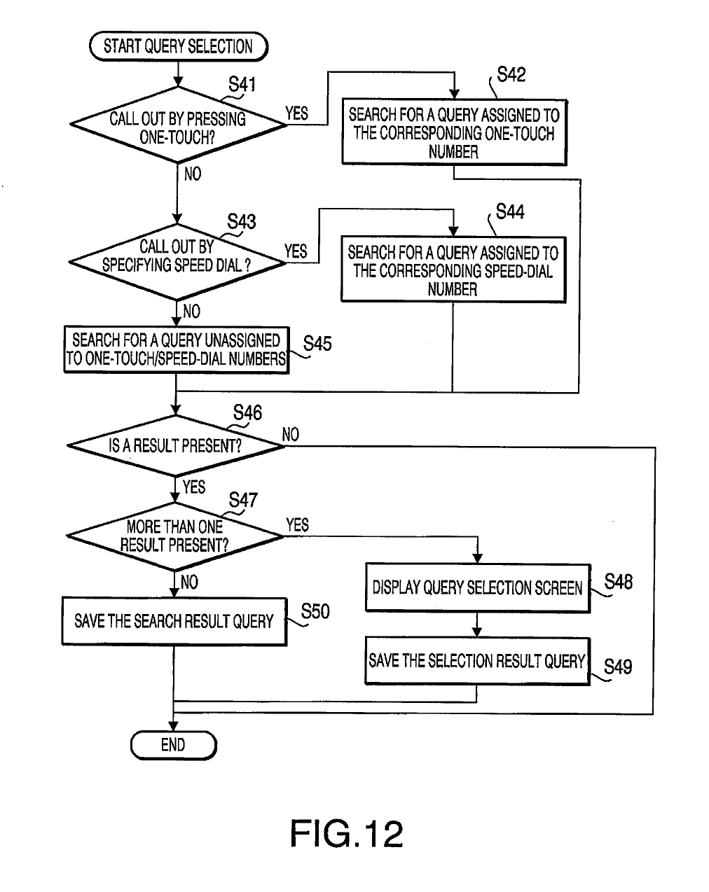

Referring to FIG. 12, the query selection process is explained hereinbelow. FIG. 12 is a flow chart showing a query selection process according to the embodiment of the invention. The query selection process is an operation of the CPU 11 of the MFP 10 to search the queries stored in the memory card 2. As the query selection process is started, if the query selection process was activated by the address directory search process assigned to one of one-touch dial buttons 21b (S41: YES), the CPU 11 of the MFP 10 selects a query assigned to the one-touch buttons 21b that is stored in the memory card 2 (S42). For example, if “1” as one of the one-touch dial buttons 21b is pressed, the CPU 11 of the MFP 10 searches for the “Query:One Touch 1” query stored in the memory card 2.

If the query selection process was not activated by the address directory search process assigned to one of the one-touch dial buttons 21b (S41: No), and if it is activated by the address directory search process assigned to one of a speed-dial (S43: Yes), the CPU 11 of the MFP 10 searches for a query assigned to the corresponding speed-dial number stored in the memory card 2 (S44). For example, if “01” as a speed-dial is specified, the CPU 11 searches for the “Query: Speed #01” query stored in the memory card 2.

If the query selection process was not activated by either of the one-touch dial button 21b or the speed-dial (S43: No), the CPU 11 searches for a query assigned to neither of the one-touch dial button 21b nor the speed-dial numbers stored in the memory card 2 (S45). For example, the CPU 11 searches for “Query::BaseDN” and “Query::Filter”.

Following S42, S44 or S45, the CPU 11 judges whether a corresponding query exists (S46). If no corresponding query is stored in the memory card 2 (S46: No), the CPU 11 terminates the query selection process.

If a corresponding query is stored in the memory card 2 (S46: Yes), and if more than one search result from the corresponding query is found (S47: Yes), the CPU 11 displays a selection screen of the corresponding query wherein one of the search results is selected by the user (S48). Thereafter, the CPU 11 saves the selected query (S49) and terminates the query selection process.

If only one search result from the corresponding query is found (S47: No), the CPU 11 saves the corresponding query as the result query (S50) and terminates the query selection process.

Thus, the CPU 11 in the MFP 10 terminates the query selection process and returns to S16 in FIG. 11. Thereafter, the CPU 11 judges whether a corresponding query was found (S17) in the query selection process in S16, and if no corresponding query was found in the memory card 2 (S17: NO), the CPU 11 obtains the search criteria stored in the MFP 10 (S25) to search the Telephone directory (S26).

If a corresponding query was found (S17: YES), the CPU 11 issues a log-in request to the directory server 30 (S18) based on the address of the directory server 30, the user name and the password obtained in S14 to execute the search process described in the query.

If the log-in to the directory server 30 fails (S19: NO), the CPU 11 replaces the query selected from the memory card 2 with a query described in an internal data format of the MFP 10 based on the items corresponding to the query so that the query is converted into the search criteria in the MFP 10 (S22). The CPU 11 searches the Telephone directory in the MFP 10 (i.e., a destination information database) (S23), and thereafter, if a search result can be obtained from the Telephone directory (S24: YES), the CPU 11 proceeds to S27. If no search result can be obtained (S24: NO), the CPU 11 proceeds to S25.

If the log-in is successful (S19: YES), the CPU 11 issues a query to the directory server 30 (S20). And if no search result of the corresponding information can be obtained from the information stored in the directory server 30 (S21: NO), the CPU 11 proceeds to S22, S23 and searches the Telephone directory in the MFP 10. If a search result of the corresponding information can be obtained from the information stored in the directory server 30 (S21: YES), the CPU 11 judges whether a query type (AllOrSelect) is “Select” (S27); if it is “Select” (S27: YES), the CPU 11 displays a search result selection screen, wherein the user selects one of the queries shown (S28). When a user selects a destination for transmission from the displayed search results, the CPU 11 displays a search result display screen (S29) and saves the search results in the memory 16, thereafter terminates the address directory search process and proceeds to S7 shown in FIG. 10.

If the query type (AllOrSelect) is not “Select” (S27: NO), the CPU 11 displays all the search results on the search result display screen (S29), and saves the search results in the memory 16, thereafter terminates the address directory search process and proceeds to S7 shown in FIG. 10.

Thus, the search criteria to retrieve the destination information from the destination information database as well as the search criteria corresponding to the one-touch dial buttons 21b and the speed-dial are stored in the memory card 2.

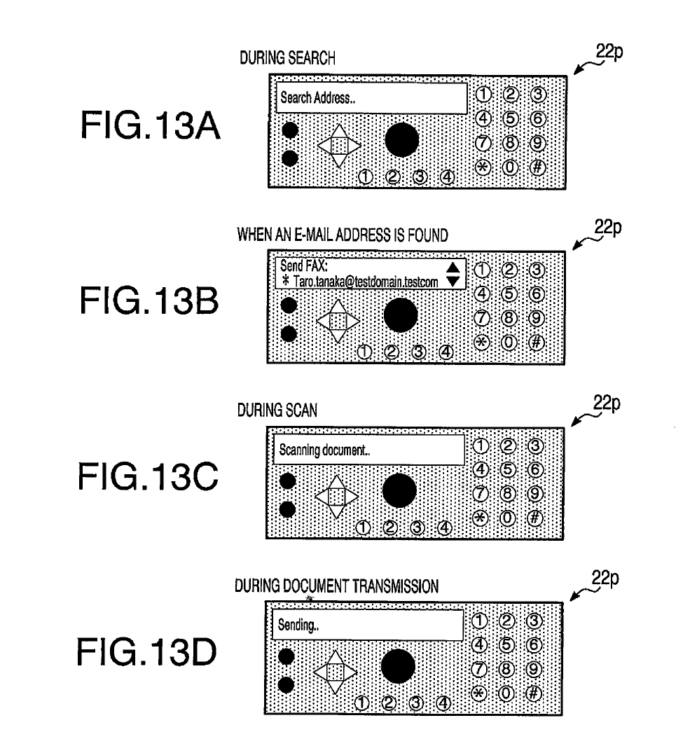

FIGS. 13A-13D illustrate screens shown on the display panel 22p according to the embodiment of the invention. FIG. 13A is a screen shown when the entry information and the address directory registered in the MFP 10 are searched. FIG. 13B is a screen showing an e-mail address.

When a desired destination information is retrieved, the MFP 10 scans documents (see FIG. 13C and S7 in FIG. 10) and runs the facsimile control program 13c and the communication program 13d to execute facsimile transmission and Internet facsimile transmission (see FIG. 13D and S8 in FIG. 10).

As described above, by storing information such as the user name, the password, the address of the directory server 30, and the search criteria in the memory card 2, and by storing a unique address of the directory server 30 in each corresponding memory card 2, it is possible for the MFP 10 to access different directory servers 30 by using different memory cards 2. Further, by storing the unique user name in each memory card 2, it is possible to set different privileges by a user basis. For example, one user may not be allowed to access addresses of irrelevant departments. In fact, this prevents access and use of irrelevant personal information for fraud.

Furthermore, as the search criteria are stored in the memory card 2 in advance, even more complicated search criteria can be set without requiring the user to input by operating the input unit 21 of the MFP 10. For example, by setting different search criteria such as “marketing department” or “outside company” in different memory cards 2, easier transmission to a desired destination can be achieved by using the appropriate memory card 2. Furthermore, the one-touch dial and the speed-dial can be assigned to each memory card 2 so that a different assignment can be set on a memory card 2 basis. Moreover, as the search criteria can be set in advance in the memory card 2, it is possible to transmit data using the information of the directory server 30 even by a data transmission apparatus having no input unit such as the input buttons 21a. Furthermore, the same search can be executed in a plurality of MFPs 10, 50 by using the same memory card 2.

Although examples of carrying out the invention have been described, those skilled in the art will appreciate that there are numerous variations and permutations of the data transmission system, data transmission method, data transmission apparatus and program therefor that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, it is also available that a memory card reader having a memory communication area is configured to communicate with the MFP 10, and the search criteria in the memory card 2 are obtained by the memory card reader.

Further, a mobile memory unit is not necessarily a card form as is with the memory card 2, but a mobile memory unit can be in any form as long as it is a mobile recording medium such as a USB memory and IC tag.

What is claimed is:

1. A communication system, comprising:
a communication apparatus;
an external memory unit, which stores a search criterion for destination information indicating a destination of communication that is designated under a predetermined criterion and is detachably attached to the communication apparatus;
wherein the communication apparatus comprising:
a reader system, which reads the search criterion stored in the memory unit;
a destination information obtaining system, which obtains the destination information that meets the search criterion read by the reader system from a destination information database; and
a destination setting system, which designates the destination of communication based on the destination information obtained by the destination information obtaining system.

2. The communication system according to claim 1,
wherein the external memory unit stores authentication information that is used for accessing the destination information database, and
wherein the communication apparatus is provided with:
an authentication information reader system which reads the authentication information from the detachable device; and
an accessing system which accesses the destination information database using the authentication information read by the authentication information reader system.

3. The communication system according to claim 1,
wherein the communication apparatus further comprises a plurality of communication units to communicate with the destination of communication,
wherein the external memory unit stores a first search criterion for designating information that designates the destination of communication and a second search criterion for communication method to communicate with the destination of communication while the designating information and the communication method of the destination of communication are associated with each other to be stored in the destination information database,
wherein the destination information obtaining system obtains the communication method that meets the second search criterion to communicate with the designation of communication that meets the first search criterion from the destination information database, and
wherein communication between the communication apparatus and the destination is established by using one of the plurality of communication units to which the communication method obtained by the destination information obtaining system is applicable.

4. The communication system according to claim 1,
wherein the communication apparatus further comprises an operation inputting system, in which an operation from a user is inputted, and
wherein the reader system reads the search criterion from the memory unit according to the operation inputted through the operation inputting system.

5. The communication system according to claim 1,
wherein the communication apparatus is capable of obtaining the destination information from a plurality of destination information databases and further comprises a judging system, which judges as to whether the destination information has been obtained from one of the plurality of destination information databases by the destination information obtaining system, and
wherein the destination information obtaining system obtains the destination information that meets the search criterion from another destination information database when the judging system judges no destination information has been obtained from the one of the plurality of destination information databases.

6. A communication apparatus, comprising:
a communication system, capable of communicating with an external memory unit that stores a search criterion for destination information indicating a destination of communication that is designated under a predetermined criterion;
a reader system, which reads the search criterion obtained from the external memory unit by using the communication system;
a destination information obtaining system, which obtains the destination information designated based on the search criterion read by the reader system from a destination information database; and
a destination setting system, which designates the destination of communication based on the destination information obtained by the destination information obtaining system.

7. A communication system, comprising:
a communication apparatus;
a destination information database wherein destination information indicating a destination of communication with the communication apparatus is stored; and
a memory unit, which stores a search criterion for the destination information that is designated under a predetermined criterion,
wherein the communication apparatus comprises:
a reader system, which reads the search criterion stored in the memory unit;
a destination information obtaining system, which obtains the destination information designated based on the search criterion read by the reader system from the destination information database; and
a destination setting system, which designates the destination of communication based on the destination information obtained by the destination information obtaining system.

8. A method of controlling a communication system, comprising:
reading a search criterion for destination information indicating a destination of communication that is designated under a predetermined criterion stored in a memory unit;
obtaining the destination information which is designated based on the search criterion read from a destination information database storing the destination information; and
designating the destination of communication based on the obtained destination information.

9. A computer usable medium comprising computer readable instructions for controlling a computer to execute steps of:
a reading step to read a search criterion for destination information indicating a destination of communication that is designated under a predetermined criterion stored in a memory unit;
a destination information obtaining step to obtain the destination information which is designated based on the search criterion read from a destination information database storing the destination information; and
a destination setting step to designate the destination of communication based on the destination information obtained in the destination information obtaining step.
